(19) United States
(12) Patent Application Publication
(10) Pub. No.: US 2021/0333671 A1
(43) Pub. Date: Oct. 28, 2021

(54) DISPLAY DEVICE

(71) Applicant: SHENZHEN CHINA STAR OPTOELECTRONICS TECHNOLOGY CO., LTD, Shenzhen, Guangdong (CN)

(72) Inventor: Xiaoli FU, Shenzhen, Guangdong (CN)

(21) Appl. No.: 16/609,442

(22) PCT Filed: Jul. 3, 2019
(86) PCT No.: PCT/CN2019/094615

§ 371 Date: Oct. 29, 2019

(30) Foreign Application Priority Data
Apr. 29, 2019 (CN) 201910357025.X

(51) Int. Cl. G02F 1/1362

(52) U.S. Cl. CPC G02F 1/136286

(57) ABSTRACT

A display device includes a display panel and a chip-on-film connected to the display panel. The display panel includes a display area, a non-display area surrounding the display area, and a plurality of data lines interval disposed in the display area, wherein the chip-on-film includes a source driving chip and a plurality of fan-out traces, ends of the plurality of fan-out traces are connected to the source driving chip, and other ends of the plurality of fan-out traces are respectively connected to the plurality of data lines in a one-to-one correspondence. A plurality of fan-out traces form a sector-shaped area, which is equivalent to setting the fan-out area of conventional art on the chip-on-film, so that the portion of the non-display area of display panels near the chip-on-film can be made narrower to achieve an ultra-narrow bezel of the display panel.

### FIELD OF INVENTION

The present invention relates to a field of display technologies, and in particular, to a display device.

### BACKGROUND OF INVENTION

Thin film transistors (TFT) are main driving components in current liquid crystal displays (LCDs) and active matrix organic light-emitting diodes (AMOLEDs), which direct relates to display performance of flat panel display devices.

Most liquid crystal displays in the current market are backlight type liquid crystal displays, which include a liquid crystal display panel and a backlight module. The working principle of the liquid crystal display panels is to fill liquid crystal molecules between a thin film transistor array substrate (TFT array substrate) and a color filter (CF) substrate, and a pixel voltage and a common voltage control are applied to two substrates, respectively. Utilizing an electric field formed between the pixel voltage and the common voltage to control rotation direction of the liquid crystal molecules, so as to transmit light of the backlight module to generate a picture.

As shown in FIG. 1, display devices of conventional art need to be connected to a plurality of data lines 203′ of a display panel 200′ through a chip-on-film 20′ having a source driving chip 10′. A plurality of fan-out traces 101′ which connect the chip-on-film 20′ and a plurality of the data lines 203′ are form a sector-shaped area called a fanout area 100′. However, conventional fan-out area 100′ has some problems. First, the fan-out area 100′ is positioned in a non-display area 201′ of the display panel 200′, due to the presence of the fan-out area 100′, the display panel 200′ cannot be realized with a narrow bezel. Secondly, in the fan-out area 100′, the fan-out traces 101′ positioned at a central of the fan-out area 100′ are shorter, and the fan-out traces 101′ positioned at both sides of the central fan-out area 100′ are longer, which results a impedance of the fan-out traces 101′ at both sides of the fan-out area 100′ is greater than a impedance of the fan-out traces 101′ in the intermediate area. Thereby resulting in signals of the data lines 203′ disposing at both sides of a display area 202′ transmitted to the display panel 200′ are significantly attenuated compared to signals of the data line 203′ transmitted to a middle of the display area 202′, and finally causes a serious undercharge problem in the two sides of the display area 202′ compared with the middle area, which is visually represented as a color shift.

### SUMMARY OF INVENTION

It is an object of the present invention to provide a display device that can realize an ultra-narrow bezel of a display panel.

To achieve the above object, the present invention provides a display device including a display panel and a chip-on-film connected to the display panel;

wherein the display panel includes a display area, a non-display area surrounding the display area, and a plurality of data lines interval disposed in the display area;

wherein the chip-on-film includes a source driving chip and a plurality of fan-out traces, ends of the plurality of fan-out traces are connected to the source driving chip, and other ends of the plurality of fan-out traces are respectively connected to the plurality of data lines in a one-to-one correspondence.

In one embodiment, the plurality of fan-out traces include central fan-out traces and a plurality of peripheral fan-out traces at either sides of the central fan-out traces; each of the plurality of peripheral fan-out traces is respectively connected to one of the plurality of data lines positioned at two sides of the display area, wherein the plurality of peripheral fan-out traces are straight lines; and each of the central fan-out traces is connected to one of the data lines positioned at a middle of the display area, wherein the central fan-out traces are curve lines.

In one embodiment, the central fan-out traces are serpentine lines.

In one embodiment, a number of the peripheral fan-out traces is six, and a number of the central fan-out traces is n minus six, wherein n is a number of the fan-out traces and n is set to be a positive integer greater than six.

In one embodiment, a number of the central fan-out traces is four, and a number of the peripheral fan-out traces is n minus four, wherein n is a number of the fan-out traces and n is set to be a positive integer greater than five.

In one embodiment, a number of the peripheral fan-out traces at one side of the central fan-out traces is same as a number of the peripheral fan-out traces at the other side of the central fan-out traces.

In one embodiment, a long side of the chip-on-film close to the display panel is connected to the display panel.

In one embodiment, a length of the chip-on-film is same as a length of the display panel.

In one embodiment, each of the peripheral fan-out traces is connected to one of the data lines positioned at the display area close to either of short edges of the display panel.

In one embodiment, the display device further including a printed circuit board connected to the chip-on-film.

Advantageous effects of present invention are as follows. A display device of the present invention includes a display panel and a chip-on-film connected to the display panel, wherein the display panel includes a display area, a non-display area surrounding the display area, and a plurality of data lines interval disposed in the display area, wherein the chip-on-film includes a source driving chip and a plurality of fan-out traces, ends of the plurality of fan-out traces are connected to the source driving chip, and other ends of the plurality of fan-out traces are respectively connected to the plurality of data lines in a one-to-one correspondence. A plurality of fan-out traces form a sector-shaped area, which is equivalent to setting the fan-out area of conventional art on the chip-on-film, so that the portion of the non-display area of display panels near the chip-on-film can be made narrower to achieve an ultra-narrow bezel of the display panel.

### BRIEF DESCRIPTION OF FIGURES

In order to further understand the characteristics and technical content of the invention, please refer to the following detailed descriptions and drawings of the invention. However, the drawings are for reference only and are not intended to restrict the invention. In the drawings,

FIG. 1 is a schematic view of a conventional display device.

FIG. 2 is a schematic view of a display device of the present invention.

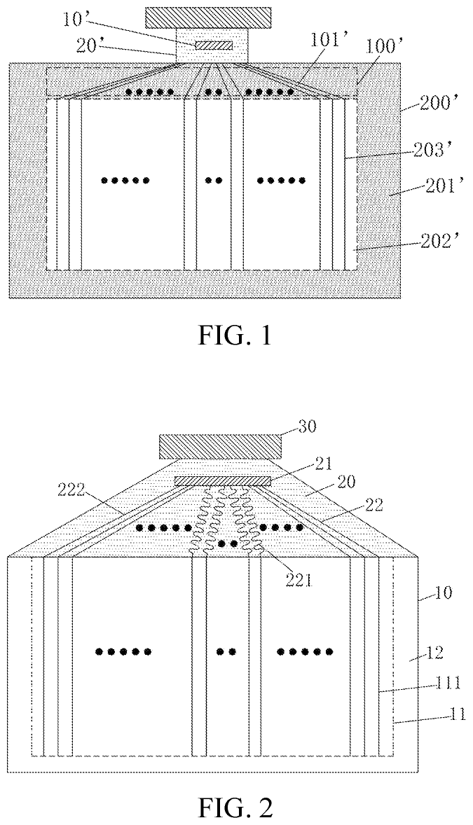

### DETAILED DESCRIPTION OF EMBODIMENTS

In order to further clarify the technical means and effects of the present invention, the following detailed description will be made in conjunction with the preferred embodiments of the invention and the accompanying drawings.

Referring to FIG. 2, the present invention provides a display device including a display panel 10 and a chip-on-film 20 connected to the display panel 10.

The display panel 10 includes a display area 11 and a non-display area 12 surrounding the display area 11, the display area 11 is provided with a plurality of data lines 111 interval disposed.

The chip-on-film 20 is provided with a source driving chip 21 and a plurality of fan-out traces 22, ends of the plurality of fan-out traces 22 are connected to the source driving chip 21, and other ends of the plurality of fan-out traces 22 are respectively connected to the plurality of data lines 11 in a one-to-one correspondence.

It should be noted that the fan-out traces 22 connecting the source driving chip 21 and the data lines 111 of the present invention is disposed on the chip-on-film 20, and a plurality of fan-out traces 22 form a sector-shaped area, which is equivalent to setting the fan-out area of conventional art on the chip-on-film 20, so that the portion of the non-display area 12 of display panel 10 near the chip-on-film 20 can be made narrower to achieve an ultra-narrow bezel of the display panel 10.

Specifically, the source driving chip 21 is configured to transmit data signals to the data lines 11 through the fan-out traces 22.

Specifically, the plurality of fan-out traces 22 include central fan-out traces 221 and a plurality of peripheral fan-out traces 222 at either sides of the central fan-out traces 221.

Each of the plurality of peripheral fan-out traces 222 is respectively connected to one of the plurality of data lines 111 positioned at two sides of the display area 11, and the plurality of peripheral fan-out traces 222 are straight lines.

Each of the central fan-out traces 221 is connected to one of the data lines 111 positioned at a middle of the display area 11, and the central fan-out traces 221 are curve lines.

That is, the present invention sets the plurality of peripheral fan-out traces 222 to be straight lines, and then the central fan-out traces 221 are curve lines, thereby increasing length of the central fan-out traces 221. The length of the central fan-out trace 221s and the length of the peripheral fan-out traces 222 are close to or consistent with each other, so that impedance of the central fan-out traces 221 and impedance of the peripheral fan-out trace 222 are close to or consistent with each other. Therefore, the data signal received by each data line 111 will not be seriously attenuated, so that the display area 11 will be charged evenly and color deviation of display devices will be improved.

Specifically, the central fan-out traces 221 are serpentine lines, and a length of each of the central fan-out traces 221 can be controlled by controlling a number of turning-coils of the serpentine line.

Specifically, a number of the peripheral fan-out traces 222 at one side of the central fan-out traces 221 is same as a number of the peripheral fan-out traces 222 at the other side of the central fan-out traces 221.

Specifically, in a preferred embodiment of the display device, a number of the plurality of peripheral fan-out traces 222 is six, and a number of the central fan-out traces 221 is n minus six (n−6), wherein n is a number of the fan-out traces 22 and n is set to be a positive integer greater than six. Since the length of the peripheral fan-out trace 222 connected to the data line 111 positioned at either sides of the display area 11 is the longest in the current art, according to the present invention, the longest six fan-out traces 22 in the current art can be set as straight lines of the peripheral fan-out traces 222, and the other fan-out traces 22 are set to the central fan-out traces 221 having curve lines, so that an entire display area 11 is uniformly charged.

Specifically, in another preferred embodiment of the display device, a number of the plurality of peripheral fan-out traces 222 is four, and a number of the central fan-out traces 221 is n minus four (n−4), wherein n is a number of the fan-out traces 22 and n is set to be a positive integer greater than five. Since the length of the central fan-out trace 221 connected to the data line 111 positioned at a middle of the display area 11 is the shortest in the current art, according to the present invention, the four shortest fan-out traces 22 in the current art can be set as curve lines of the central fan-out traces 221, and other fan-out traces 22 are set to the peripheral fan-out traces 222 having straight lines, so that an entire display area 11 is uniformly charged.

Specifically, a shape of the display panel 10 is a rectangle.

Further, a long side of the chip-on-film 20 close to the display panel 10 is connected to the display panel 10.

Further, a length of the chip-on-film 20 is same as a length of the display panel 10.

Specifically, a shape of the display area 11 is a rectangle.

Further, each of the peripheral fan-out traces 222 is connected to one of the data lines 111 positioned at the display area 11 close to either of short edges of the display panel 10.

Specifically, the display device further includes a printed circuit board (PCB) 30 connected to the chip-on-film 20.

In summary, the display device of the present invention includes a display panel and a chip-on-film connected to the display panel, wherein the display panel includes a display area, a non-display area surrounding the display area, and a plurality of data lines interval disposed in the display area, wherein the chip-on-film includes a source driving chip and a plurality of fan-out traces, ends of the plurality of fan-out traces are connected to the source driving chip, and other ends of the plurality of fan-out traces are respectively connected to the plurality of data lines in a one-to-one correspondence. A plurality of fan-out traces form a sector-shaped area, which is equivalent to setting the fan-out area of conventional art on the chip-on-film, so that the portion of the non-display area of display panels near the chip-on-film can be made narrower to achieve an ultra-narrow bezel of the display panel.

Embodiments of the present invention have been described, but not intending to impose any unduly constraint to the appended claims. For a person skilled in the art, any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A display device, comprising:
a display panel and a chip-on-film connected to the display panel;
wherein the display panel comprises a display area, a non-display area surrounding the display area, and a plurality of data lines intervally disposed in the display area;
wherein the chip-on-film comprises a source driving chip and a plurality of fan-out traces, ends of the plurality of fan-out traces are connected to the source driving chip, and other ends of the plurality of fan-out traces are respectively connected to the plurality of data lines in a one-to-one correspondence.

2. The display device as claimed in claim 1, wherein the plurality of fan-out traces comprise central fan-out traces and a plurality of peripheral fan-out traces at either sides of the central fan-out traces;
each of the plurality of peripheral fan-out traces is respectively connected to one of the plurality of data lines positioned at two sides of the display area, wherein the plurality of peripheral fan-out traces are straight lines; and
each of the central fan-out traces is connected to one of the data lines positioned at a middle of the display area, wherein the central fan-out traces are curve lines.

3. The display device as claimed in claim 2, wherein the central fan-out traces are serpentine lines.

4. The display device as claimed in claim 2, wherein a number of the peripheral fan-out traces is six, and a number of the central fan-out traces is n minus six, wherein n is a number of the fan-out traces and n is set to be a positive integer greater than six.

5. The display device as claimed in claim 2, wherein a number of the central fan-out traces is four, and a number of the peripheral fan-out traces is n minus four, wherein n is a number of the fan-out traces and n is set to be a positive integer greater than five.

6. The display device as claimed in claim 2, wherein a number of the peripheral fan-out traces at one side of the central fan-out traces is same as a number of the peripheral fan-out traces at the other side of the central fan-out traces.

7. The display device as claimed in claim 2, wherein a long side of the chip-on-film close to the display panel is connected to the display panel.

8. The display device as claimed in claim 7, wherein a length of the chip-on-film is same as a length of the display panel.

9. The display device as claimed in claim 7, wherein each of the peripheral fan-out traces is connected to one of the data lines positioned at the display area close to either of short edges of the display panel.

10. The display device as claimed in claim 1, further comprising a printed circuit board connected to the chip-on-film.
